(19) United States
(12) Patent Application Publication
(10) Pub. No.: US 2019/0378467 A1
(43) Pub. Date: Dec. 12, 2019

(54) HEAD MOUNT DISPLAY

(71) Applicant: SHARP KABUSHIKI KAISHA, Sakai City, Osaka (JP)

(72) Inventor: TAKUYA OKAMOTO, Sakai City, Osaka (JP)

(21) Appl. No.: 16/486,731

(22) PCT Filed: Dec. 20, 2017
(86) PCT No.: PCT/JP2017/045679

§ 371 Date: Aug. 16, 2019

(30) Foreign Application Priority Data
Feb. 20, 2017 (JP) 2017-029389

(51) Int. Cl. G09G 3/34; G06T 7/90; G09G 3/20

(52) U.S. Cl. CPC G09G 3/3413; G09G 3/2003; G09G 3/342; G06T 7/90

(57) ABSTRACT

The present invention gives a strong sense of immersion to a user. A head mount display (100) includes: a housing (1); a display section (2) which is provided in the housing and displays an image (I); a lens (3a, 3b) which is provided in the housing and through which the display section (2) is visible to a user; and at least one light emitting section (4) which is provided in the housing (1) and emits light with which to illuminate a circumference of a counter surface (3a-1, 3b-1) of the lens (3a, 3b) which counter surface faces an eye of the user.

### TECHNICAL FIELD

The present invention relates to a head mount display.

### BACKGROUND ART

In recent years, a technique for enlarging a display region of a display device such as a TV has been actively researched and developed so that a user can enjoy a more powerful image. For example, Patent Literature 1 discloses a display device including an emission means for emitting, toward a back surface and/or a side surface of a housing in which a display panel is provided, light radiated by a light source which is provided on a back surface of the display panel.

### CITATION LIST

### Patent Literature

[Patent Literature 1]

Japanese Patent Application Publication Tokukai No. 2011-39204 (Publication date: Feb. 24, 2011)

### SUMMARY OF INVENTION

### Technical Problem

Note, however, that, in a case where the technique disclosed in Patent Literature 1 is applied to a head mount display, hardly any indirect illumination effect that is brought about by a reflection of light radiated by a light source can be obtained around a lens which is provided in a housing of the head mount display. Note here that, since a field of view of a user is restricted by, for example, the shape and size of a lens, the following problem occurs. Specifically, the problem is that application of the technique disclosed in Patent Literature 1 to a head mount display is insufficient to achieve a wider field of view and it is therefore impossible to give the user a strong sense of immersion.

An aspect of the present invention has been made in view of the problem, and an object of the present invention is to achieve a head mount display which allows a user to have a strong sense of immersion.

### Solution to Problem

In order to attain the object, a head mount display in accordance with an aspect of the present invention includes: a housing; a display section which is provided in the housing and displays an image; a lens which is provided in the housing and through which the display section is visible to a user; and at least one light emitting section which is provided in the housing and emits light with which to illuminate a circumference of a counter surface of the lens which counter surface faces an eye of the user.

### Advantageous Effects of Invention

An aspect of the present invention allows a user to have a strong sense of immersion in a case where a circumference of a counter surface of a lens is illuminated with light emitted from a light emitting section.

### BRIEF DESCRIPTION OF DRAWINGS

FIG. 1 is a view schematically illustrating a configuration of a head mount display in accordance with Embodiment 1 of the present invention.

FIG. 2 is a functional block diagram illustrating a functional configuration of the head mount display.

FIG. 3 is a view showing an example of an analysis target region of an image displayed in a display screen of an image display section.

FIG. 4 is a flowchart showing a method for turning on an LED in a screen peripheral edge color in the head mount display.

FIG. 5 is a view schematically illustrating a configuration of a head mount display in accordance with Embodiment 2 of the present invention.

FIG. 6 is a view schematically illustrating a configuration of a head mount display in accordance with Embodiment 3 of the present invention.

FIG. 7 is a functional block diagram illustrating a functional configuration of the head mount display.

FIG. 8 is a flowchart showing a method for turning on an LED in a screen peripheral edge color in the head mount display.

### DESCRIPTION OF EMBODIMENTS

### Embodiment 1

<Overview of Head Mount Display>

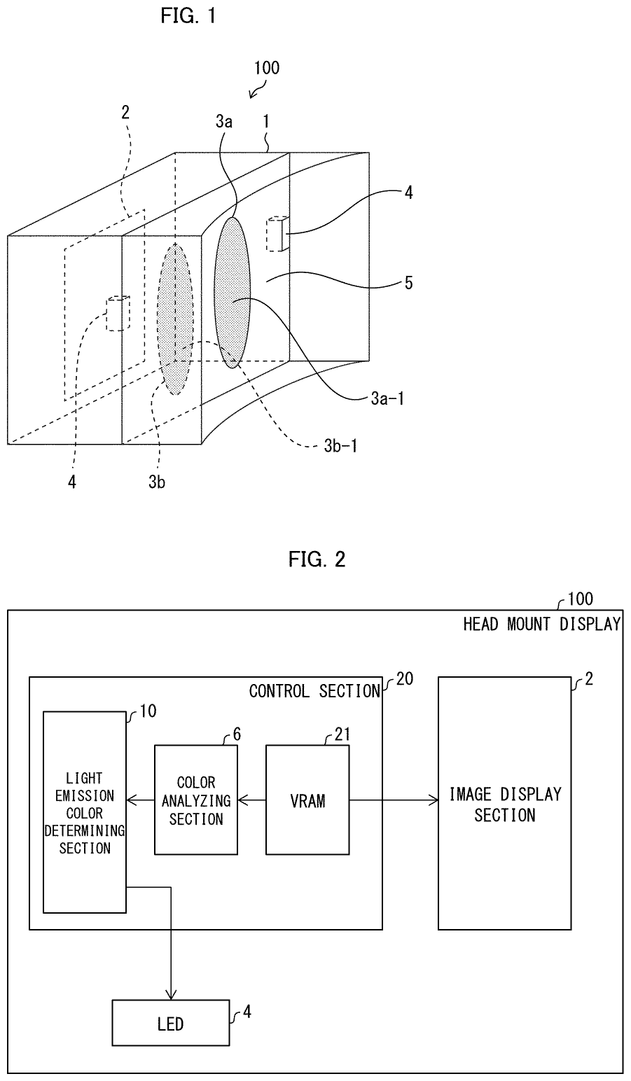

First, an overview of a head mount display 100 in accordance with an embodiment of the present invention is described below with reference to FIG. 1. FIG. 1 is a view schematically illustrating a configuration of the head mount display 100.

The head mount display 100 is a display device which can be mounted on the head of a user. As illustrated in FIG. 1, the head mount display 100 is an immersive head mount display which is binocular and completely covers eyes of the user while being mounted on the head of the user. Same applies to head mount displays 200 and 300 described later.

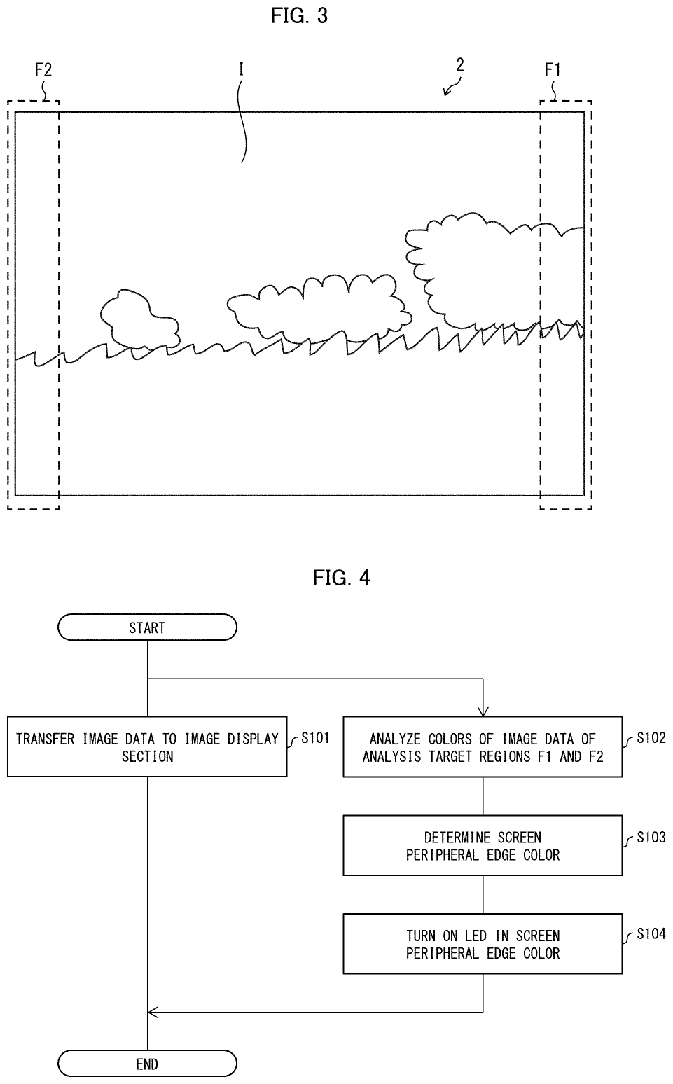

Specifically, the head mount display 100 includes an image display section 2 (display section) provided in a housing 1. The image display section 2 includes a display screen including a plurality of pixels to which image data is to be written. An image I (see FIG. 3) indicated by the image data is displayed in the display screen by changing, for each of the pixels, an amount of transmission of light emitted from a backlight (not illustrated) which is provided on a back surface of the image display section 2. The description of Embodiment 1 takes, as an example, a case where a single display section (image display section 2) is provided in the housing 1. Note, however, that a head mount display in accordance with an aspect of the present invention is applicable to a head mount display including a plurality of display sections which are provided in a housing. Alternatively, a head mount display in accordance with an aspect of the present invention is also assumed to be applied to a display including no backlight (e.g., an organic EL display).

The housing 1 has an inner part partitioned by a first light guide plate 5. The first light guide plate 5 includes a region which faces a right eye of the user and in which a right eye lens 3a (lens) is provided. Meanwhile, the first light guide plate 5 includes a region which faces a left eye of the user and in which a left eye lens 3b (lens) is provided. The right eye lens 3a is a lens through which for the user to look at the image I, displayed in the display screen of the image display section 2, with the right eye, whereas the left eye lens 3b is a lens through which for the user to look at the image I with the left eye. The first light guide plate 5 guides light, emitted from respective LEDs 4 (described later), to respective circumferences of the right eye lens 3a and the left eye lens 3b.

The first light guide plate 5 has edges each of which extends in a shorter side direction of the first light guide plate 5 and which are provided with the respective LEDs 4 (light emitting sections). In a case where an edge of the first light guide plate 5 which edge is closer to the right eye lens 3a is provided with a corresponding one of the LEDs 4, a circumference of a first counter surface 3a-1 (counter surface) of the right eye lens 3a, which first counter surface 3a-1 faces the right eye of the user, is illuminated with light emitted from the corresponding one of the LEDs 4. In a case where an edge of the first light guide plate 5 which edge is closer to the left eye lens 3b is provided with a corresponding one of the LEDs 4, a circumference of a second counter surface 3b-1 (counter surface) of the left eye lens 3b, which second counter surface 3b-1 faces the left eye of the user, is illuminated with light emitted from the corresponding one of the LEDs 4. Colors of light emitted from the respective two LEDs 4 are adjusted by a light emission color determining section 10 (described later).

Note that the above-described arrangement and number of the LEDs 4 is merely an example. The arrangement and number of the LEDs 4 can be arbitrarily changed provided that the circumference of the first counter surface 3a-1 of the right eye lens 3a and the circumference of the second counter surface 3b-1 of the left eye lens 3b can each be illuminated with an LED 4. Note also that the LED 4 can alternatively be replaced with a light source different from the LED 4.

Alternatively, many LEDs 4 can be provided at respective desired places in the inner part of the housing 1 so that an analysis target region (described later) is set in a wider range. This allows the user to have a stronger sense of immersion and a stronger sense of realism. In this case, the circumference of the first counter surface 3a-1 of the right eye lens 3a and the circumference of the second counter surface 3b-1 of the left eye lens 3b can be illuminated by merely light emission by the LEDs 4 depending on the number of LEDs 4, so that the first light guide plate is dispensable (not illustrated).

In other words, in a case where many (a plurality of) LEDs 4 are provided in the inner part of the housing 1 and the many LEDs 4 merely emit light, the circumference of the first counter surface 3a-1 of the right eye lens 3a and the circumference of the second counter surface 3b-1 of the left eye lens 3b can be illuminated with light emitted from the LEDs 4.

<Functional Configuration of Head Mount Display>

Next, a functional configuration of the head mount display 100 is described below with reference to FIG. 2 and FIG. 3. FIG. 2 is a functional block diagram illustrating a functional configuration of the head mount display 100. FIG. 3 is a view showing an example of analysis target regions F1 and F2 of the image I displayed in the display screen of the image display section 2.

As illustrated in FIG. 2, the head mount display 100 includes a control section 20. The control section 20 is a circuit which collectively controls sections of the head mount display 100. The control section 20 generates image data to be displayed in the display screen of the image display section 2. The image data generated is temporarily stored in a video random access memory (VRAM) 21 provided in the control section 20. Then, the image data is read from the VRAM 21 and transferred to the image display section 2 at a predetermined timing.

In a case where the image data is transferred from the VRAM 21 to the image display section 2, the image data is written to the display screen of the image display section 2, so that the image I (see FIG. 3) is displayed in the display screen.

Furthermore, the control section 20 controls (i) an operation, carried out by the image display section 2, to write the image data and (ii) an operation to turn on/off the backlight. Note, however, that the above operations (i) and (ii) can alternatively be controlled by the image display section 2.

Note that the control section 20 can be provided in the head mount display 100 or can be an external device which is provided to the head mount display 100. Alternatively, for example, the control section 20 can be a network server which is used via a communication section (not illustrated) of the head mount display 100.

The control section 20 includes the color analyzing section 6 and the light emission color determining section 10 (each of which is a light emission color adjusting section). The color analyzing section 6 analyzes a color of the image I which is displayed in the display screen of the image display section 2. Specifically, the color analyzing section 6 (i) reads image data of the image I which image data is stored in the VRAM 21 and (ii) separates, into RGB components, a color of each of dots of pieces of image data which pieces are included in the image data read and correspond to image parts constituting the respective analysis target regions F1 and F2. Then, the color analyzing section 6 analyzes a color of the image data of the image I by measuring respective luminance values of color components (an R component, a G component, and a B component) of the each of the dots. An analysis result is transmitted to the light emission color determining section 10.

Note here that the analysis target regions F1 and F2 each refer to a specific region of the image I. The specific region is to be analyzed during analysis of the color of the image I by the color analyzing section 6. According to Embodiment 1, the analysis target regions F1 and F2 are a right-hand region and a left-hand end region, respectively, of the image I as viewed in FIG. 3 (see FIG. 3). Note that the analysis target regions F1 and F2 illustrated in FIG. 3 are merely an example. An analysis target region whose position, shape, and size are proper can be set as appropriate in accordance with a relative position of a lens and a light source (light emitting section).

The light emission color determining section 10 which has received an analysis result of a color of the image I displayed in the display screen of the image display section 2 determines, in accordance with the analysis result, a screen peripheral edge color, which is a color of light emitted by the LEDs 4. Specifically, the light emission color determining section 10 which has received the analysis result from the color analyzing section 6 calculates, for each of the color components, a sum of luminance values of the color components of each of dots of image data corresponding to image parts constituting the respective analysis target regions F1 and F2. Then, by calculating averages by dividing the sum of the luminance values of the color components by the number of dots, the light emission color determining section 10 determines that a color represented by a combination of the averages of the luminance values for each of the color components is the screen peripheral edge color. Furthermore, the light emission color determining section 10 controls turning-on of the LEDs 4 so that the LEDs 4 emit light whose color is the screen peripheral edge color.

The light emission color determining section 10 and the color analyzing section 6 (described earlier) constitute the light emission color adjusting section in accordance with an aspect of the present invention. The light emission color adjusting section (i) analyzes a color of the image I displayed in the display screen of the image display section 2 and (ii) adjusts, in accordance with an analysis result, a color of light emitted by the LEDs 4.

Note that the light emission color determining section 10 can determine the screen peripheral edge color by any method that is not limited to the method described above. For example, the light emission color determining section 10 can (i) calculate, by a histogram, frequency values of luminance values of colors of dots corresponding to the image parts constituting the respective analysis target regions F1 and F2 and (ii) determine that a color represented by a luminance value which has the highest frequency value is the screen peripheral edge color. In this case, a range of a luminance value of, for example, ±5 is set as a calculation target, and a median of ±5 is set as a frequency value.

A color of light emitted by the LEDs 4 does not necessarily need to be adjusted by, for example, the light emission color determining section 10. The circumference of the first counter surface 3a-1 of the right eye lens 3a and the circumference of the second counter surface 3b-1 of the left eye lens 3b only need to be illuminated, at a minimum level, with light emitted by a certain light emitting section.

<Method for Turning on LED in Screen Peripheral Edge Color>

Next, the following description discusses, with reference to FIG. 4, a method for turning on the LEDs 4 in the screen peripheral edge color in the head mount display 100. FIG. 4 is a flowchart showing a method for turning on the LEDs 4 in the screen peripheral edge color in the head mount display 100.

Concurrently with transfer, to the image display section 2, of image data of one (1) frame which image data is stored in the VRAM by the control section 20, (step S101, “step” is hereinafter omitted), the color analyzing section 6 analyzes respective colors of pieces of the image data which pieces (i) are included in the image data of the image I displayed in the display screen and (ii) correspond to image parts corresponding to the respective analysis target regions F1 and F2 (S102). An analysis result is transmitted to the light emission color determining section 10. Note here that image data of one (1) frame refers to image data displayed in the display screen of the image display section 2 one time.

Subsequently, the light emission color determining section 10 which has received the analysis result determines an image peripheral edge color (S103) and then turns on the LEDs 4 so that the LEDs 4 emit light of the screen peripheral edge color (S104). In a case where the steps S101 through S104 are repeated times as many as predetermined frames, all image data are displayed in the display screen while the circumference of the first counter surface 3a-1 of the right eye lens 3a and the circumference of the second counter surface 3b-1 of the left eye lens 3b are illuminated with light in the screen peripheral edge color.

### Embodiment 2

Another embodiment of the present invention is described below with reference to FIG. 5. Note that, for convenience, members having functions identical to those of the respective members described in Embodiment 1 are given respective identical reference signs, and a description of those members is omitted here.

The head mount display 200 in accordance with Embodiment 2 differs from the head mount display 100 in accordance with Embodiment 1 in that the head mount display 200 includes no image display section 2, and, instead, the head mount display 200 allows a smartphone 50 including a display section 50a to be provided in a housing 1a. The head mount display 200 in accordance with Embodiment 2 also differs from the head mount display 100 in accordance with Embodiment 1 in that the head mount display 200 includes no color analyzing section 6 and no light emission color determining section 10, and, instead, includes second light guide plates 4a.

<Overview of Head Mount Display>

An overview of the head mount display 200 in accordance with an embodiment of the present invention is described below with reference to FIG. 5. FIG. 5 is a view schematically illustrating a configuration of the head mount display 200.

In the housing 1a of the head mount display 200, a space (not illustrated) is formed which has a size and a shape that (i) allow the smartphone 50 to be contained in the space and (ii) allow the smartphone 50 which is contained in the space to be positionally fixed. Furthermore, an opening (not illustrated) which has a size and a shape that allow the smartphone 50 to be inserted through the opening is formed on a side surface of the housing 1a. This allows the space and the opening to communicate with each other.

The smartphone 50 is inserted through the opening so that the display section 50a of the smartphone 50 which is contained in the space faces each of a right eye lens 3a and a left eye lens 3b. This allows the smartphone 50 to be provided in the housing 1a in such a state as illustrated in FIG. 5. Specifically, the head mount display 200 is a so-called slot-in type head mount display. Note that the other structures of the housing 1a are similar to those of the housing 1 in accordance with Embodiment 1.

The smartphone 50 (information processing device) is a multifunctional portable telephone which has functions of, for example, a personal computer and a personal digital assistant (PDA, portable information terminal) simultaneously. The display section 50a of the smartphone 50 includes, for example, a touch panel and a circuit which carries out a display process. The display section 50a causes, for example, the image I (see FIG. 3) and a cursor to be displayed on a display surface of the touch panel. The description of Embodiment 2 takes, as an example, a case where the smartphone 50 is provided in the housing 1a. Note, however, that the head mount display 200 can be used by providing, in the housing 1a, a certain information processing device including a display section, such as a portable game machine.

The second light guide plates 4a (light guide plates), which are rectangular, are provided at respective positions inside the housing 1a so as to face respective edges of the display section 50a, which edges extend in a shorter side direction of the display section 50a. One of the second light guide plates 4a is a member for guiding, to a circumference of a first counter surface 3a-1 of the right eye lens 3a, light coming from an image part which is included in the image I displayed in the display surface of the touch panel and constitutes the analysis target region F1 (see FIG. 3). The other of the second light guide plates 4a is a member for guiding, to a circumference of a second counter surface 3b-1 of the left eye lens 3b, light coming from an image part which is included in the image I and constitutes the analysis target region F2 (see FIG. 3).

The second light guide plates 4a have respective ends each of which is connected to a first light guide plate 5. Light guided to the respective ends of the second light guide plates 4a is further guided, by the first light guide plate 5, to the circumference of the first counter surface 3a-1 of the right eye lens 3a and the circumference of the second counter surface 3b-1 of the left eye lens 3b, respectively. A color of light of the image I displayed in the display surface of the touch panel is naturally adjusted while the light is being guided by the second light guide plates 4a to the respective ends of the second light guide plates 4a. Specifically, the second light guide plates 4a each function as a light emitting section from which light of an image peripheral edge color is emitted through an end thereof.

Note that the arrangement, number, and shape of the second light guide plates 4a (described earlier) is merely an example. Specifically, the arrangement, number, and shape of the second light guide plates 4a can be arbitrarily changed provided that the second light guide plates 4a can illuminate the circumference of the first counter surface 3a-1 of the right eye lens 3a and the circumference of the second counter surface 3b-1 of the left eye lens 3b.

(Variation)

The configuration of the housing 1a in accordance with Embodiment 2, i.e., the configuration in which the second light guide plates 4a are provided instead of the color analyzing section 6 and the light emission color determining section 10 can be applied to a housing that includes a display section in advance, such as the housing 1 in accordance with Embodiment 1.

For example, in a case where two second light guide plates 4a instead of the color analyzing section 6 and the light emission color determining section 10 are provided in the inner part of the housing 1 in accordance with Embodiment 1 (not illustrated), one of the second light guide plates 4a guides, to the circumference of the first counter surface 3a-1 of the right eye lens 3a, light coming from the image part which is included in the image I displayed in the display screen of the image display section 2 and constitutes the analysis target region F1. The other of the second light guide plates 4a guides, to the circumference of the second counter surface 3b-1 of the left eye lens 3b, light coming from the image part which is included in the image I displayed in the display screen of the image display section 2 and constitutes the analysis target region F2.

### Embodiment 3

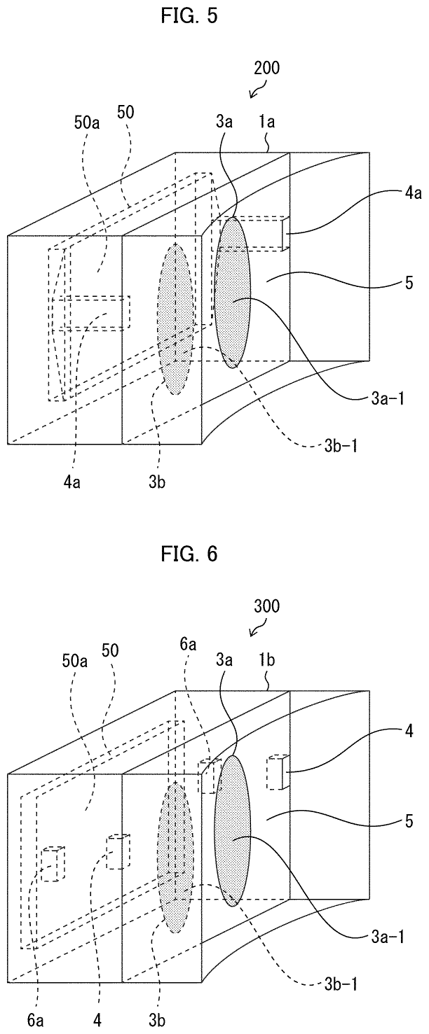

A further embodiment of the present invention is described below with reference to FIGS. 6 through 8. Note that, for convenience, members having functions identical to those of the respective members described in Embodiment 1 are given respective identical reference signs, and a description of those members is omitted here.

<Overview of Head Mount Display>

An overview of the head mount display 300 in accordance with an embodiment of the present invention is described below with reference to FIG. 6. FIG. 6 is a view schematically illustrating a configuration of the head mount display 300.

As in the case of the head mount display 200, the head mount display 300 is a slot-in type head mount display which allows a smartphone 50 to be provided in a housing 1b (see FIG. 6). Unlike the housing 1a in accordance with Embodiment 2, the housing 1b has an inner part in which no second light guide plates 4a are provided, and, instead, color sensors 6a (light emission color adjusting sections) and a light emission color determining section 10 (not illustrated in FIG. 6) are provided. Furthermore, LEDs 4 are provided in the inner part of the housing 1b.

The color sensors 6a are provided at respective positions inside the housing 1b so as to face respective edges of a display section 50a of the smartphone 50, which edges extend in a shorter side direction of the display section 50a. The color sensors 6a each analyze a color of an image I displayed in a display surface of the display section 50a. Specifically, the color sensors 6a, each of which is a combination of a color filter and a photodiode, cause the color filter to separate, into RGB components, a color of each of dots which are included in a plurality of dots constituting the image I and correspond to image parts constituting respective analysis target regions F1 and F2. Then, the color analyzing sections 6 cause the photodiode to detect respective luminance values of color components (an R component, a G component, and a B component) of the each of the dots. An analysis result (a result of the detection by the photodiode) is transmitted to the light emission color determining section 10.

The arrangement and number of the color sensors 6a can be arbitrarily changed provided that the color sensors 6a can detect the color of the image I displayed in the display surface of the display section 50a of the smartphone 50. Instead of the color sensors 6a, spectroscopic sensors, for example can alternatively be provided. Specifically, any sensors can be used provided that those sensors can analyze the color of the image I displayed in the display surface of the display section 50a.

Note that the other structures of the housing 1b are similar to those of each of the housing 1 in accordance with Embodiment 1 and the housing 1a in accordance with Embodiment 2. The LEDs 4 provided in the housing 1b 1 are similar in arrangement and number to the LEDs 4 provided in the housing 1 in accordance with Embodiment 1.

<Functional Configuration of Head Mount Display>

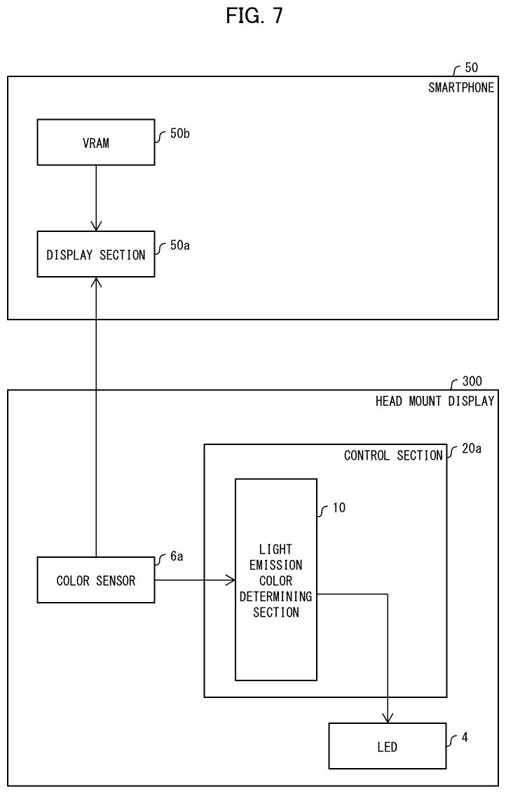

Next, a functional configuration of the head mount display 300 is described below with reference to FIG. 7. FIG. 7 is a functional block diagram illustrating the functional configuration of the head mount display 300.

As illustrated in FIG. 7, the head mount display 300 includes a control section 20a. The control section 20a is a circuit which collectively controls sections of the head mount display 300. Note, however, that, unlike the control section 20 in accordance with Embodiment 1, the control section 20a neither generates image data nor transfers the image data to the display section 50a.

Image data is generated by the smartphone 50, and the image data thus generated is temporarily stored in a VRAM 50b provided in the smartphone 50. In a case where the image data is transferred from the VRAM 50b to the display section 50a, the image data is written to the display surface of the display section 50a, so that the image I (see FIG. 3) is displayed in the display screen.

The control section 20a includes the light emission color determining section 10 as in the case of the control section 20 in accordance with Embodiment 1. The light emission color determining section 10 determines a screen peripheral edge color in accordance with an analysis result, received from the color sensors 6a, of the color of the image I displayed in the display surface of the display section 50a. Note that Embodiment 3 is similar to Embodiment 1 in (i) method in which the light emission color determining section 10 determines the screen peripheral edge color and (ii) control, carried out by the light emission color determining section 10, of turning-on/off the LEDs 4.

<Method for Turning on LED in Screen Peripheral Edge Color>

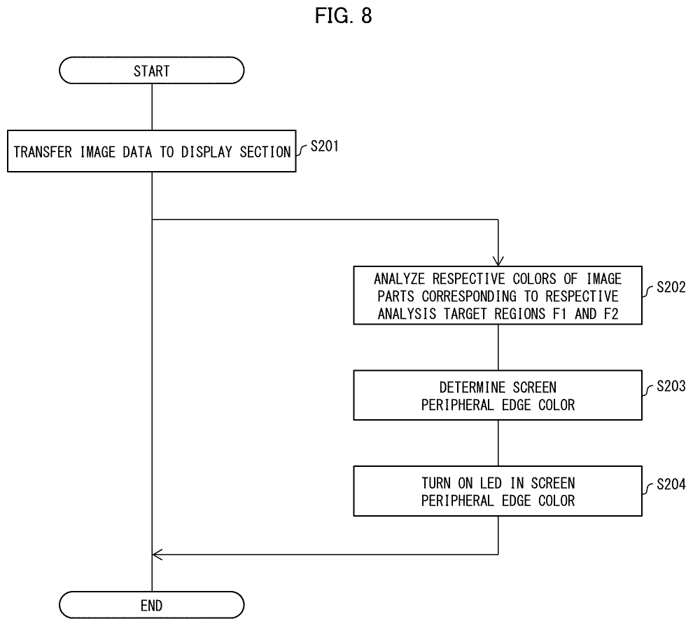

Next, the following description discusses, with reference to FIG. 8, a method for turning on the LEDs 4 in the screen peripheral edge color in the head mount display 300. FIG. 8 is a flowchart showing a method for turning on the LEDs 4 in the screen peripheral edge color in the head mount display 300.

In a case where, in the smartphone 50, image data of one (1) frame is transferred to the display section 50a by the VRAM 50b and the image data is written to the display surface (specifically, a plurality of pixels) of the display section 50a (S201), the color sensors 6a analyze respective colors of image parts which are included in the image I displayed in the display surface and correspond to the respective analysis target regions F1 and F2 (S202). An analysis result is transmitted to the light emission color determining section 10.

Subsequently, the light emission color determining section 10 which has received the analysis result determines an image peripheral edge color (S203) and then turns on the LEDs 4 so that the LEDs 4 emit light of the screen peripheral edge color (S204).

[Software Implementation Example]

Control blocks of each of the head mount displays 100 and 300 (in particular, the color analyzing section 6, and the light emission color determining section 10 and the control section 20) can be realized by a logic circuit (hardware) provided in an integrated circuit (IC chip) or the like or can be alternatively realized by software as executed by a central processing unit (CPU).

In the latter case, the head mount displays 100 and 300 each include a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that an aspect of the present invention can also be implemented by the program in the form of a computer data signal embedded in a carrier wave which is embodied by electronic transmission.

Aspects of the present invention can also be expressed as follows:

A head mount display (100, 200, 300) in accordance with a first aspect of the present invention includes: a housing (1, 1a, 1b); a display section (image display section 2, 50a) which is provided in the housing and displays an image (I); a lens (right eye lens 3a, left eye lens 3b) which is provided in the housing and through which the display section is visible to a user; and at least one light emitting section (LEDs 4, second light guide plates 4a) which is provided in the housing and emits light with which to illuminate a circumference of a counter surface (first counter surface 3a-1, second counter surface 3b-1) of the lens which counter surface faces an eye of the user.

With the configuration, a circumference of a counter surface of a lens is illuminated with light emitted by the light emitting section. This makes it possible to apparently widen a user's field of view which has been restricted by, for example, the shape and size of the lens. Thus, the user can obtain a strong sense of immersion by wearing the head mount display in accordance with an aspect of the present invention.

In a second aspect of the present invention, a head mount display (100, 300) can be configured, in the first aspect of the present invention, to further include a light emission color adjusting section (color analyzing section 6, color sensor 6a, light emission color determining section 10) configured to analyze a color of the image and adjust, in accordance with an analysis result, a color of the light which is emitted by the at least one light emitting section.

With the configuration, by analyzing a color of an image displayed in the display section, the light emission color adjusting section can adjust a color of light, emitted by the light emitting section, so that the color of the light harmonizes with the image. This allows the user to obtain not only a sense of immersion but also a strong sense of realism.

In a third aspect of the present invention, a head mount display can be configured such that, in the second aspect of the present invention, the light emission color adjusting section analyzes a color of an edge region (analysis target regions F1 and F2) of the image. With the configuration, by analyzing a color of an edge region of an image displayed in the display section, the light emission color adjusting section can adjust a color of light, emitted by the light emitting section, so that the color of the light harmonizes with a background formed in the image. This allows the user to obtain not only a sense of immersion but also a stronger sense of realism.

In a fourth aspect of the present invention, a head mount display (200, 300) can be configured such that, in any one of the first through third aspects of the present invention, the head mount display allows an information processing device (smartphone 50) including the display section (50a) to be provided in the housing (1a, 1b). The configuration allows the user to obtain a strong sense of immersion also from a head mount display of a type which is used by providing, in a housing, an information processing device including a display section.

In a fifth aspect of the present invention, a head mount display (100, 300) can be configured such that: in any one of the first through fourth aspects of the present invention, the at least one light emitting section which is provided in the housing comprises a plurality of light emitting sections; and the circumference of the counter surface is illuminated with the light merely by light emission by a corresponding one of the plurality of light emitting sections.

With the configuration, the circumference of the counter surface is illuminated with the light merely by light emission by a corresponding one of the plurality of light emitting sections. This dispenses with a member for guiding, to the circumference of the counter surface of the lens, light emitted by the corresponding one of the plurality of light emitting sections. Furthermore, an increase in number of light emitting sections makes it possible to apparently widen the user's field of view so that details can be seen in a broader area. Thus, with a simple structure, it is possible to achieve a head mount display which allows the user to have a stronger sense of immersion.

In a sixth aspect of the present invention, a head mount display (200) can be configured such that, in the first aspect of the present invention, the at least one light emitting section which is provided in the housing is a light guide plate (second light guide plate 4a) which guides, to the circumference of the counter surface of the lens, light coming from the display section.

With the configuration, while light coming from the display section is being guided by the light guide plate, a color of the light is naturally adjusted so that the light harmonizes with an image. This makes it possible to apparently widen the user's field of view without the need to provide, in the housing, any light emitting material (e.g., an LED) or any electric power source for turning on the light emitting material. Thus, it is possible to give the user a stronger sense of immersion and a stronger sense of realism while reducing cost by causing the head mount display to have a simple structure.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b Housing
2 Image display section (display section)
3a Right eye lens (lens)
3a-1 First counter surface (counter surface)
3b Left eye lens (lens)
3b-1 Second counter surface (counter surface)
4 LED (light emitting section)
4a Second light guide plate (light guide plate)
6 Color analyzing section (light emission color adjusting section)
6a Color sensor (light emission color adjusting section)
10 Light emission color determining section (light emission color adjusting section)
50 Smartphone (information processing device)
50a Display section
100, 200, 300 Head mount display
F1, F2 Analysis target region (edge region)
I Image

1. A head mount display comprising:
a housing;
a display section which is provided in the housing and displays an image;
a lens which is provided in the housing and through which the display section is visible to a user; and
at least one light emitting section which is provided in the housing and emits light with which to illuminate a circumference of a counter surface of the lens which counter surface faces an eye of the user.

2. The head mount display as set forth in claim 1, further comprising a light emission color adjusting section configured to analyze a color of the image and adjust, in accordance with an analysis result, a color of the light which is emitted by the at least one light emitting section.

3. The head mount display as set forth in claim 2, wherein the light emission color adjusting section analyzes a color of an edge region of the image.

4. The head mount display as set forth in claim 1, wherein the head mount display allows an information processing device including the display section to be provided in the housing.

5. The head mount display as set forth in claim 1, wherein:
the at least one light emitting section which is provided in the housing comprises a plurality of light emitting sections; and
the circumference of the counter surface is illuminated with the light merely by light emission by a corresponding one of the plurality of light emitting sections.

6. The head mount display as set forth in claim 1, wherein the at least one light emitting section which is provided in the housing is a light guide plate which guides, to the circumference of the counter surface of the lens, light coming from the display section.
